(19) United States
(12) Patent Application Publication
(10) Pub. No.: US 2025/0258025 A1
(43) Pub. Date: Aug. 14, 2025

(54) DEVICE AND METHOD FOR METROLOGICALLY DETECTING CHARACTERISTICS OF MEASUREMENT OBJECTS

(71) Applicant: Micro-Epsilon-Messtechnik Gmbh & Co. K.G., Ortenburg (DE)

(72) Inventors: Hannes LOFERER, Ortenburg (DE); Andreas LIEBL, Vilshofen (DE); Thomas WISSPEINTNER, Ortenburg (DE); Bernhard SCHIERZ, Puchenau (AT)

(21) Appl. No.: 18/866,951

(22) PCT Filed: May 12, 2023
(86) PCT No.: PCT/DE2023/200097

§ 371 Date: Nov. 18, 2024

(30) Foreign Application Priority Data
May 18, 2022 (DE) 10 2022 204 922.5

(51) Int. Cl. G01D 21/02

(52) U.S. Cl. CPC G01D 21/02

(57) ABSTRACT

A device and method for metrologically detecting characteristics of measurement objects, having a measuring device having at least one positioning unit and at least one measuring unit, a calculation module and an evaluation unit having an evaluation module. The positioning unit configured to position the measurement object and the measuring unit relative to each other. The measuring unit detects measurement data of the measurement object, in which an image of the measurement object can be generated by the calculation module from the position data and the measurement data. A standardized interface for the transmission of data is formed between the calculation module and the evaluation module. Transmitted data is both data of the measuring unit and data of the positioning unit.

### CROSS REFERENCE

This application is a national stage entry application under 37 U.S.C. 371 of PCT Patent Application No. PCT/DE2023/200097 filed on 12 May 2023, which claims priority to German Patent Application No. 10 2022 204 922.5, filed on 18 May 2022 the entire contents of each of which are incorporated herein by reference.

### FIELD

The present disclosure relates to a device for metrologically capturing properties of measurement objects, comprising a measurement device having at least one positioning unit and at least one measurement unit, a computation module and an evaluation module, wherein the positioning unit positions the measurement object and the measurement unit relative to one another and the measurement unit captures measurement values or measurement data from the measurement object, wherein a representation of the measurement object is able to be generated by the computation module from the position data and the measurement data.

Furthermore, the disclosure relates to a method for metrologically capturing properties of measurement objects.

### BACKGROUND

Devices and methods for optically measuring measurement objects are used in numerous applications in industry, research and development. Such measurement devices generally consist of a positioning unit, a measurement unit and an evaluation unit. The positioning unit is used to move the measurement object relative to the measurement unit into a measurement position or to position the measurement unit relative to the measurement object. The measurement unit captures properties of the measurement object by means of a measurement system that, depending on the property that is to be examined of the measurement object, operates according to a physical measurement principle adapted thereto. The evaluation unit controls the positioning unit and captures the measurement values of the measurement unit. The control signals of the positioning unit are transmitted via an interface, as are the measurement values or measurement data from the sensor unit. Digital interfaces are predominantly used nowadays on account of the relatively high flexibility. In this case, a distinction is made between the (physical) hardware interface and the software protocol running over it. Different layers, of which the lowermost layer generally forms the (physical) hardware interface, are defined for digital interfaces. Different layers of software protocols that build on one another are located thereabove, starting from transport layers up to the uppermost layer of the application layer (for example according to the ISO/OSI reference model or the TCP/IP reference model). In the evaluation unit, the data thus transmitted are then further processed and visualized or forwarded for further use at superordinate controllers.

The ISO/OSI layer model was developed as early as the 1970s in order to depict the advancing development in the area of interfaces and networks between computers. Layer 1 (physical layer) represents the physical connection. Simple serial interfaces such as, for example, RS232 or RS422, which are also still used today are depicted there. Layer 2 (data link layer) already provides error handling and data flow control, known protocols are SDLC or HDLC or else Ethernet. Layer 3 (network layer) describes the switching of connections or the forwarding of data packets with the best-known protocol IP (Internet protocol) that represents the basis of the Internet. 4 Layer (transport layer) regulates the end-to-end control of data traffic, known protocols are UDP (user datagram protocol) or TCP (transmission control protocol).

Layers 1 to 4 describe standardization of the network-related layers used, that is to say “how” data are transmitted between the measurement unit, the positioning unit and the evaluation unit. The semantics of the data transmitted are proprietary and manufacturer-specific. Located above these are layers 5 to 7, which are the application-related layers that define the structure and meaning of the data, that is to say “what” is intended to be transmitted. This is where the protocols that interact with application programs reside.

Another representation of the layer model is provided by the TCP/IP reference model with four layers that build on one another. The first three largely correspond to layers 1 to 4 of the ISO/OSI model. The application layer then sits on top as the last layer.

Digital interfaces for industrial applications usually contain freely definable areas with which specific parameters that are suitable for the respective application may be specified by the user, for example for measurement units such as sensors or cameras or else positioning units such as linear axes or robots. These are used to parameterize the respectively associated unit. Such interfaces should generally be assigned to the higher layers of the reference models, since it is defined there “what” is intended to be transmitted (in the example, the application-specific or user-specific parameters).

Industrial interfaces such as, for example, Profibus, Interbus or EtherCAT are frequently used to actuate positioning units. This allows specific positioning parameters to be set, such as, for example, starting position, acceleration and braking ramps and feed, etc.

For all types of measurement systems, there are standardized interfaces with a transmission protocol according to specified standards. Examples of such interfaces are I²C, IO-Link or CAN bus. Interfaces such as, for example, GigE Vision or CameraLink have been established for optical measurement means, in particular cameras. Particular camera parameters such as, for example, exposure time, resolution, frame rate, etc. are then able to be set with the aid of freely definable areas in order to adapt the camera to the respective measurement task.

Known measurement devices according to the prior art use separate interfaces for actuating or regulating the positioning unit and transmitting the measurement values from the measurement unit, for example, GigE Vision for the camera and EtherCAT for the positioning unit. In the superordinate evaluation unit, the interfaces are then frequently addressed via proprietary application software in order to establish the communication between the measurement or the positioning unit and the evaluation unit. This application software therefore has to use two interfaces, specifically an interface for the positioning unit and an interface for the measurement unit. Proprietary means that the manufacturer of the measurement device creates its own application software that is capable of exchanging data with the measurement unit and the positioning unit, processing said data and providing same to the user in a suitable form. In this case, two interfaces have to be programmed, specifically one for the interface for the positioning unit and a second for the interface for the measurement unit.

Instead of proprietary application software, application software on the market is also used. Programming outlay is then also necessary to create a proprietary interface and possibly to adapt the commercially available application software.

The disadvantage of such proprietary solutions is therefore the high level of programming outlay, since individual adaptations are required depending on the model of the measurement device. Furthermore, a proprietary solution is detached from the development of standards.

### SUMMARY

The present disclosure is therefore based on the object of designing and developing a device and a method of the type mentioned at the outset such that it is possible to capture the properties of the measurement object with a low level of programming outlay.

According to the present disclosure, the above object with regard to the device is achieved, in an embodiment, by the features of claim 1. Accordingly, the device in question is for metrologically capturing properties of measurement objects and includes a measurement device having at least one positioning unit and at least one measurement unit, a computation module and an evaluation module, wherein the positioning unit positions the measurement object and the measurement unit relative to one another and the measurement unit captures measurement data from the measurement object, wherein a representation of the measurement object is able to be generated by the computation module from the position data and the measurement data, characterized in that a standardized interface for transmitting data is formed between the computation module and the evaluation module, and in that the transmitted data are both data from the measurement unit and data from the positioning unit.

With regard to the method, the above object is achieved, in an embodiment, by the features of alternative independent claim 9. This claim specifies a method for properties metrologically capturing of measurement objects, in particular including a device as claimed in one of claims 1 to 8, including a measurement device having at least one positioning unit and at least one measurement unit, a computation module and an evaluation the module, wherein measurement object and the measurement unit are positioned relative to one another by the positioning unit and measurement data from the measurement object are captured by the measurement unit, wherein a representation of the measurement object is generated by the computation module from the position data and the measurement data, wherein both data from the measurement unit and data from the positioning unit are transmitted between the computation module and the evaluation module via a standardized interface.

According to the present disclosure, it has been recognized that, in addition to the data from the measuring unit that are specified initially by the standardized interface, it is additionally also possible to use the same interface to transmit data that are intended for the positioning unit, or vice versa. To this end, by way of example, freely definable areas of the interface or freely definable areas in the protocol of the interface may be used to transport data for the positioning unit. The freely definable areas may, for example, be in the form of a defined block in the data stream, or an addressable memory area, or a data area in a configuration file (e.g. XML file). The advantage is that it is possible to use a standardized interface and proprietary software does not have to be generated. It is furthermore advantageous that it is also possible to use standardized or commercially available standard software for the further processing of the data (measurement data and position data), provided that the standard software supports this standardized interface.

In other words, the use of a standardized interface affords the advantage that no proprietary software has to be programmed in the evaluation unit, but rather it is possible to use commercially available evaluation software that is compatible with the standard (for example GenICam), such as, for example, Halcon, as the evaluation module. Alternatively, commercially available evaluation units that are compatible with the standard could likewise be used.

The teaching according to the present disclosure may include the following features:
A positioning unit positioning a measurement object, relative to a measurement unit, or vice versa, in one, two or three spatial axes and angles (including rotations, for example 6-axis robot), wherein position data of the measurement object and/or the positioning unit are determined.

Capturing properties of the measurement object using the measurement unit, wherein measurement values or measurement data are generated.

Generating a consistent data set in a computation module that contains position data and measurement data.
Outputting the data set via a digital interface.
Controlling the measurement machine via the same interface.
This interface is standardized, but may have specific, freely definable or parameterizable areas.
These specific areas could have both data for the positioning unit and data for the measurement unit.

One exemplary configuration of the measurement device may have:
A positioning unit, for example linear axis, x-y table, manipulator, robot, or similar devices using which an object in space may be brought into a possibly predefinable position relative to another object.

A measurement unit, for example measurement device, sensor, camera, scanner for capturing geometric (e.g. distance, position, contour, geometry, etc.), optical (e.g. color, gloss level, texture, etc.) or other properties (e.g. magnetic properties, roughness, etc.) of a measurement object or of the surface thereof.

The control unit may be a computer (e.g. industry PC, microcontroller, PLC) that, on the one hand, prescribes the control commands for a control module of f the positioning unit and, on the other hand, calculates the position data of the positioning unit with the measurement values or measurement data from the measurement unit to form a consistent data set, and therefore generates a representation of the measurement object.

The interface may be a digital interface with a standardized protocol (e.g. GenICam for image processing), which connects the computation module and the evaluation module.

It is pointed out in this case that, in the context of this disclosure, the term “GenICam” should be understood to be the generic programming interface for cameras (“generic interface for cameras”) that is supported by the European Machine Vision Association (EMVA).

The use of GenICam provides the possibility of reproducing additional parameters besides the settings defined in the standard. In this case, the structure for embedding the additional parameters is in turn specified by the standard. GenICam makes provision for the server (in this case, the computation module) to describe its behavior via an XML file (what is known as GenICam.xml). By way of example, this file contains the following as freely definable areas:
mandatory entries that each GenICam server has to specify
   version numbers
   device designation
optional standard entries that a GenICam server may specify
   field of view
   exposure time
   resolution

GenICam provides the possibility that, in addition to the camera-specific parameters mentioned above, additional user-defined parameters that may be used to actuate the positioning unit may also be transmitted via the same interface. To this end, user-defined features may be defined freely in the GenICam.xml according to the standard features naming convention (SFNC). For the actuation of a positioning unit, these may, for example, be parameters such as
measurement speed of the measurement unit
positioning speeds
axis limits
acceleration ramps

According to the standard, category features may be combined. It is then expedient to form a category, for example for the parameters that are intended for the positioning unit.

According to the present disclosure, it has therefore been recognized that additional features that are also able to be transmitted on a non-camera-specific basis (in this case specific parameters of the positioning unit) may be defined in the GenICam standard actually provided for the camera actuation. It is therefore possible to use a standardized interface (GenICam) without additional programming outlay in order to control both a measurement unit and a positioning unit.

In an embodiment, the measurement unit may capture one-dimensional (point sensor), two-dimensional (line scanner) or three-dimensional (camera) measurement values or measurement data. Furthermore, a multidimensional representation the measurement of object could be obtained by the positioning unit moving the measurement unit or the measurement object (along specified trajectories) (only one relative movement is necessary). The measurement values could be captured depending on the (relative or absolute) position and a 2D or 3D data set, which corresponds to an image or a point cloud (both referred to as “representation” in the context of this disclosure), could be generated.

In the context of this disclosure, the term “representation” should be understood in the general sense, in particular a representation may also include measurement values that do not, strictly speaking, represent an image, but rather a spatial arrangement of measurement values such as, for example, a temperature distribution, a color distribution, etc.

By way of example, a distance sensor that measures in a point-by-point manner (for example a laser triangulation sensor) could be used to generate an image of the surface or the surface contour by scanning the surface in two axes (x-axis and y-axis).

Other examples of measurement units and the representations able to be generated therewith may be:
the distribution of the surface temperature of a measurement object is determined by way of a temperature sensor,
the geometry and/or the roughness of the surface of a measurement object is determined by way of a confocal sensor,
the color gradient of the surface of a measurement object is determined by way of a color sensor,
a representation of the surface of a measurement object is generated by way of a movement of a line scanner in an axis,
a representation of the surface of a measurement object is generated directly by way of a camera,
the thickness of a measurement object is determined by way of one or more displacement or position sensors.

In the case of relatively large measurement objects, it may be necessary, by way of scanning, to string together and stitch individual images.

In the case of the device according to the present disclosure and the method according to the present disclosure, the position of the measurement object in space relative to the measurement unit is known, since either the positioning unit contains integrated position measurement or the position is determined using external sensors. High absolute accuracy of the positioning unit is not necessarily required. It is also conceivable for a representation to be generated without position measurement if, for example, the positioning unit moves uniformly, that is to say moves at the same speed. In this case, the knowledge of the starting point is sufficient. The starting point could also be a feature of the measurement object (e.g. edge), upon the capture of which by the measurement unit a trigger signal is generated.

It is typically necessary that the representation, which is thus generated, of the measurement object is forwarded to a superordinate evaluation unit for further processing via a standardized interface such as is known in image processing, for example. A constituent part of the evaluation unit is an evaluation module that carries out the evaluation operations desired by the user on the representation of the measurement object. By way of example, this may be the evaluation of particular geometric properties of the measurement object, such as shape deviation, dimensional accuracy or dimensions.

In an embodiment, the positioning unit may have a control module, with the result that the control is effected by way of the control module. It is conceivable in this case for control signals for the drive (motor, linear drive) to be calculated in the computation module from the parameters transmitted via the freely definable area of the interface. It is particularly advantageous if, in addition to the actuation parameters, position data are also transmitted. A downstream evaluation module is then able to read and process these data (in both directions) provided that the evaluation module supports the standard of the standardized interface, for example the GenICam standard. By way of example, the measurement data are thus already able to be assigned to the position data in the control module and a representation of the measurement object is therefore able to be generated. This representation could then be transmitted to the evaluation module via the standardized interface to the evaluation unit for further evaluation. In an entirely analogous way, freely definable areas of an interface for positioning units could also be used for parameterizing a measurement unit.

In an embodiment, the measurement device could have a control unit for actuating the positioning unit. The computation module could be arranged in the control unit. The data could then already be pre-processed in the computation module of the measurement device. Furthermore, modeling could already take place in the control unit. This means that the modeling of the measurement device could already be carried out in the control unit by the manufacturer. Outwardly, the measurement device then behaves like a unit that is compatible with the standard and has device-specific characteristics. The standardized interface to an evaluation unit then provides the possibility of using commercially available evaluation units. This can be, for example, any computer that the user already owns or acquires, on which standard evaluation software (such as Halcon, which has been mentioned already) then runs as the evaluation module. In the example of GenICam, the measurement device itself therefore functions as a GenICam server, which transmits data (representations) that are compatible with the standard to any evaluation software or evaluation units that are compatible with the standard.

It is pointed out that the device according to the present disclosure has features that may have a form in line with the method. These features and the advantages achieved thereby may expressly be a constituent part of the method according to the present disclosure.

There are now various possibilities for configuring and developing the teaching of the present disclosure. This may be accomplished by referring firstly to the claims subordinate to claims 1 and 9 and secondly to the following explanation of exemplary embodiments of the present disclosure with reference to the drawing. In conjunction with the explanation of the exemplary embodiments of the present disclosure with reference to the drawing, configurations and developments of the teaching are also explained.

### BRIEF DESCRIPTION OF THE DRAWINGS

FIG. 1 shows a schematic illustration of an exemplary embodiment of a measurement device,

FIG. 2 shows a schematic illustration of the exemplary embodiment according to FIG. 1 comprising functional units according to the prior art,

FIG. 3 shows a schematic illustration of the exemplary embodiment according to FIG. 1 comprising functional units according to the present disclosure,

FIG. 4 shows a schematic illustration of the exemplary embodiment according to FIG. 1 comprising a further exemplary embodiment of functional units according to the present disclosure, and

FIG. 5 shows a schematic illustration of the structure of the XML file in the GenICam standard.

### DETAILED DESCRIPTION OF THE DISCLOSURE

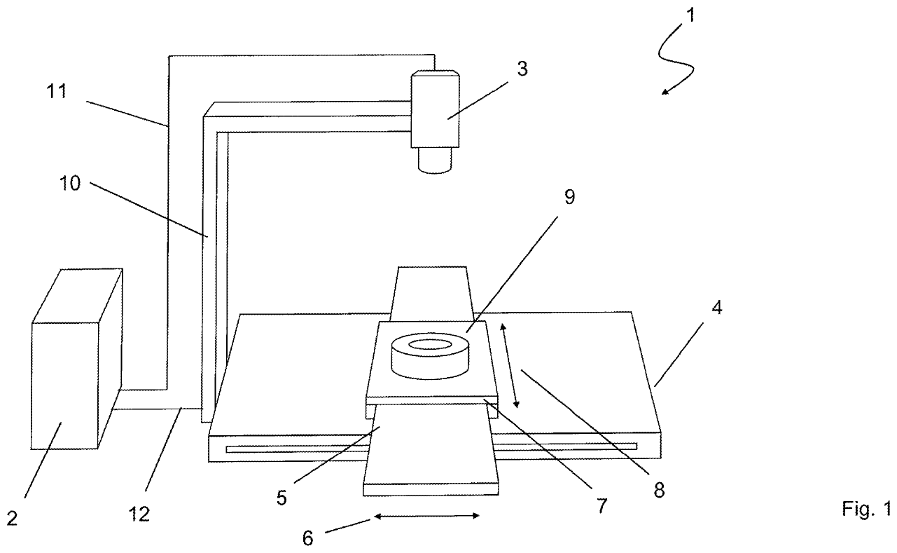

FIG. 1 shows a device for metrologically capturing properties of a measurement object 9. The device has a measurement device 1 and an evaluation unit 2. The measurement device 1 contains a measurement unit 3 and a positioning unit 4 in the form of an x-y table in which a first linear slide 5 is able to move in the x-direction 6 (symbolized by the double arrow) and a second linear slide 7 is able to move in the y-direction 8 (symbolized by the double arrow). As a result, a measurement object 9 is able to be positioned in two axes x, y, in each case relative to the measurement unit 3. The measurement unit 3 is mounted above the x-y table by way of a suitable holder 10. If the measurement unit 3, for example, is a laser triangulation sensor with point-by-point measurement evaluation, the measurement object 9 may be scanned and the surface thereof measured as a result. In the example, this is a metal cylinder having a hole in the middle. The measurement device 1 is controlled by way of the evaluation unit 2 that is connected to the measurement device 1 by a first interface 11 for the measurement unit 2 and a second interface 12 for the positioning unit 4 (interfaces 11, 12 only shown schematically).

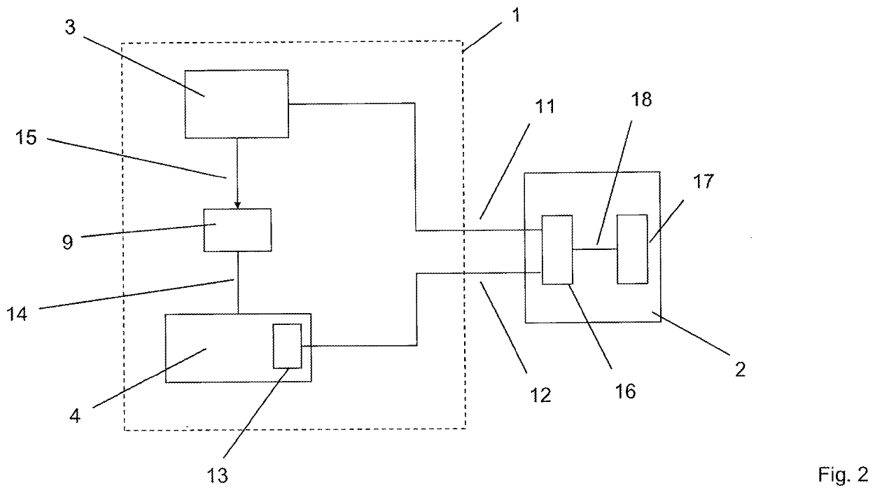

FIG. 2 shows a schematic illustration of the device from FIG. 1, comprising functional units according to the prior art. In the prior art, the interface between the measurement device 1 and the evaluation unit 2 consists of two separate interfaces 11, 12. One interface 11 connects the measurement unit 3 to the evaluation unit 2, the other interface 12 connects the x-y table 4 to the evaluation unit 2. An interface that is common in measurement technology is usually used for the first interface 11. For measurement units 3 that represent image processing in the broadest sense, this is GenICam, for example. The second interface 12 is generally an interface as is used in automation technology to actuate the axes of the x-y table, for example ProfiBus. The positioning unit 4 contains a control module 13 for actuating the linear axes. The measurement object 9 is guided using the positioning unit 4 (shown symbolically by line 14) and positioned relative to the measurement unit 3. The measurement unit 3 captures measurement values or measurement data from the measurement object 9 (shown symbolically by arrow 15) that are calculated in a computation module 16 using the position data from the positioning unit 4, with the result that a representation of the measurement object is generated. In the example from FIG. 1, the representation is the geometry of the metal cylinder in the form of a 3D data set. In this case, the computation module 16 is a constituent part of the evaluation unit 2. The evaluation unit 2 furthermore contains an evaluation module 17. The evaluation module 17 is connected to the computation module 16 via a proprietary interface 18.

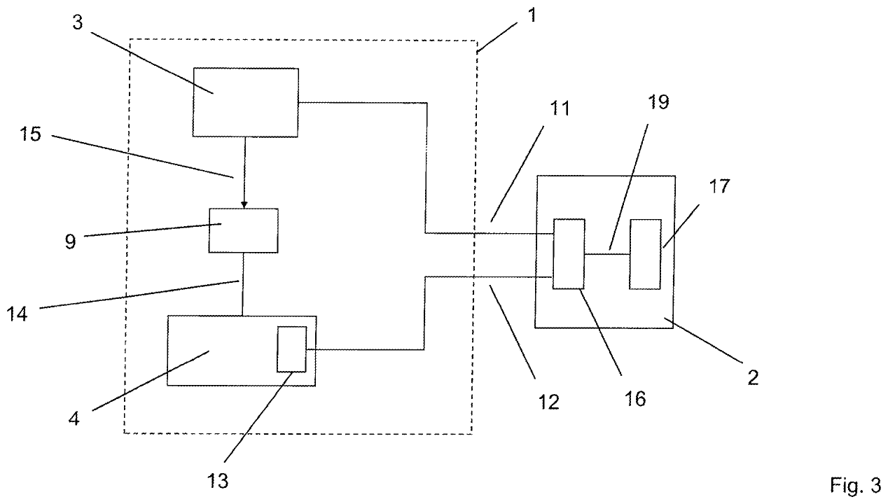

FIG. 3 shows an embodiment, according to the present disclosure, of the device from FIG. 2. Instead of a proprietary interface 18, a standardized interface 19 that transmits both data for the measurement unit 3 and data for the positioning unit 4 between the computation module 16 and the evaluation module 17 is used. As a result of using the standardized interface 19, it is possible to use evaluation software that is compatible with the standard as the evaluation module 17.

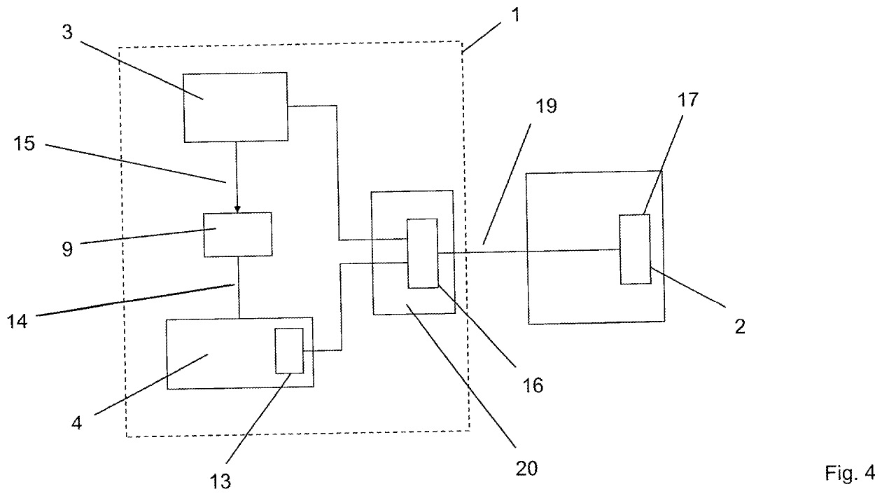

FIG. 4 shows a further embodiment according to the present disclosure that includes a measurement device 1 that contains a control unit 20 with a computation module 16. The data from the measurement unit (measurement values, parameters) and the positioning unit (position data, parameters) are pre-processed in the computation module 16 of the control unit 20. A standardized interface 19 is used as the interface between the control unit 20 and the evaluation unit 2. In this case, the control unit 20 actuates the linear axes 5, 7 (not shown in the figure) that position the measurement object 9 relative to the measurement unit 3. At the same time, the control unit 20 receives the measurement data from the measurement unit 3 and links these to the position data in the to form computation module 16 a representation of the measurement object. The representation is then transmitted via the standardized interface 19 to the evaluation unit 2, where it is further processed and evaluated in the evaluation module 17.

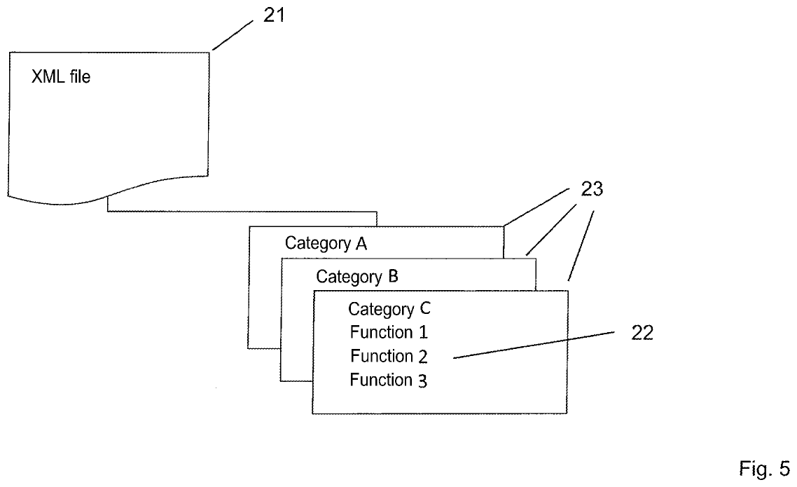

Finally, FIG. 5 shows a very schematic illustration of the structure of the XML file 21 according to the GenICam standard. Features 22 that define user-specific or application-specific parameters are defined in the XML file 21. In this case, features 1, 2, 3 of the positioning unit are combined in a category 23.

With regard to further advantageous embodiments of the teaching according to the present disclosure, reference is made to the general part of the description and to the appended claims in order to avoid repetitions.

Finally, it should be expressly pointed out that the above-described exemplary embodiments of the teaching according to the present disclosure serve merely to discuss the claimed teaching, but do not restrict it to the exemplary embodiments.

### LIST OF REFERENCE SIGNS

1 Measurement device
2 Evaluation unit
3 Measurement unit
4 Positioning unit
5 Linear slide
6 x-direction
7 Linear slide
8 y-direction
9 Measurement object
10 Holder
11 Interface (measurement unit-evaluation unit)
12 Interface (positioning unit-evaluation unit)
13 Control module
14 Guide (measurement object)
15 Measurement data
16 Computation module
17 Evaluation module
18 Proprietary interface
19 Standardized interface
20 Control unit
21 XML file
22 Features
23 Category

1. A device for metrologically capturing properties of measurement objects, comprising:
a measurement device having at least one positioning unit and at least one measurement unit,
a computation module, and
an evaluation unit having an evaluation module, wherein the positioning unit positions the measurement object and the measurement unit relative to one another and the measurement unit captures measurement data from the measurement object, wherein a representation of the measurement object is able to be generated by the computation module from the position data and the measurement data, wherein a standardized interface for transmitting data is formed between the computation module and the evaluation module, and wherein the transmitted data are both data from the measurement unit and data from the positioning unit.

2. The device as claimed in claim 1, wherein the transmitted data are at least one of: measurement data, position data, correction values, model data, control commands, diagnostic information, status information and parameters.

3. The device as claimed in claim 1, wherein the representation is the combination of position data and measurement data.

4. The device as claimed in claim 1, wherein the standardized interface has at least one of freely definable areas and parameterizable areas, wherein these areas are used to transmit the data.

5. The device as claimed in claim 1, wherein the standardized interface is GenICam.

6. The device as claimed in claim 1, wherein the computation module is assigned as one of a constituent part of the evaluation unit, or and as a constituent part of the measurement device.

7. The device as claimed in claim 1, wherein the measurement unit has at least one of a sensor, a camera, a scanner for capturing geometric properties, a scanner for capturing optical properties, and a scanner for capturing other properties.

8. The device as claimed in claim 1, wherein the positioning unit has at least one of: a linear axis; an x-y table; a manipulator; and a robot.

9. A method for metrologically capturing properties of measurement objects using a measurement device having at least one positioning unit and at least one measurement unit, a computation module and an evaluation module, comprising:
positioning the measurement object and the measurement unit relative to one another by the positioning unit
capturing measurement data from the measurement object by the measurement unit,
generating a representation of the measurement object by the computation module from the position data and the measurement data,
wherein both data from the measurement unit and data from the positioning unit are transmitted between the computation module and the evaluation module via a standardized interface.

10. The method as claimed in claim 9, wherein the standardized interface has at least one of freely definable areas and parameterizable areas, wherein these areas are used to transmit the data.

11. The device as claimed in claim 3, wherein the representation is one of a geometry. a surface, a temperature distribution and a color distribution.

12. The device as claimed in claim 7, wherein the scanner for capturing geometric properties captures at least one of a distance, a position, a thickness, a contour and a geometry.

13. The device as claimed in claim 7, wherein the scanner for capturing optical properties captures at least one of a color, a gloss level and a texture.

14. The device as claimed in claim 7, wherein the scanner for capturing other properties captures at least one of magnetic properties and roughness.
